(19) United States
(12) Patent Application Publication
(10) Pub. No.: US 2026/0296206 A1
(43) Pub. Date: Oct. 1, 2026

(54) Methods of Electric Vehicle On-board Energy Dissipation

(71) Applicants: The Regents of The Univesity of Michigan, Ann Arbor, MI (US); The University of California, Merced, Merced, CA (US)

(72) Inventors: Anna Stefanopoulou, Ann Arbor, MI (US); Jason Siegel, Ann Arbor, MI (US); Vivian Tran, Ann Arbor, MI (US); Ricardo de Castro, Merced, CA (US); Joseph Drallmeier, Ann Arbor, MI (US)

(21) Appl. No.: 19/630,683

(22) Filed: Mar. 27, 2026

Related U.S. Application Data
(60) Provisional application No. 63/780,844, filed on Mar. 31, 2025.

(51) Int. Cl. B60L 3/00; B60L 1/02; B60L 1/14; B60L 15/00; B60L 58/12; B60L 58/24; H01M 10/42; H01M 10/48; H01M 10/613; H01M 10/625; H01M 10/6568; H01M 10/667

(52) U.S. Cl. CPC B60L 3/0046; B60L 1/02; B60L 1/14; B60L 15/007; B60L 58/12; B60L 58/24; H01M 10/425; H01M 10/482; H01M 10/486; H01M 10/613; H01M 10/625; H01M 10/6568; H01M 10/667; B60L 2210/40; B60L 2240/545; H01M 2010/4271; H01M 2220/20

(57) ABSTRACT

An electric vehicle comprises: a battery pack; an electric traction motor; an inverter in electrical communication with the battery pack and the traction motor; an electrical load in electrical communication with the battery pack; and a controller in electrical communication with the battery pack, the inverter, and the electrical load. The controller receives electrical signals from a sensor in or adjacent the battery pack, and when an electrical signal exceeds a safety threshold, causes electricity to flow from the battery pack to the inverter and/or to the electrical load to dissipate energy stored in the battery pack. The controller can also cause electricity to flow from the battery pack to the inverter and/or to the electrical load to dissipate energy stored in the battery pack, and calculate a battery pack characteristic during or after when the electricity flows from the battery pack to the inverter and/or to the electrical load.

### CROSS-REFERENCES TO RELATED APPLICATIONS

This application is based on, claims benefit of, and claims priority to U.S. Application No. 63/780,844 filed on Mar. 31, 2025, which is hereby incorporated by reference herein in its entirety for all purposes.

### STATEMENT REGARDING FEDERALLY SPONSORED RESEARCH

Not Applicable.

### FIELD OF THE INVENTION

This invention relates to electric vehicles including on-board energy dissipation, methods using on-board energy dissipation for determining one or more characteristics of a battery pack in an electric vehicle, and methods using on-board energy dissipation for mitigating or avoiding an unsafe condition in a battery pack in an electric vehicle.

### BACKGROUND

All-electric vehicles include a battery pack and utilize electric power for the entirety of their motive power. A plug in power source is needed for all-electric vehicles for charging. Hybrid electric vehicles include both an internal combustion engine and a battery pack. The internal combustion engine can turn a generator, which supplies a current to charge the battery pack and/or supplies current to the electric motor to move the electric vehicle (EV). Electric vehicles typically include a battery management system (BMS) for oversight of the battery pack, which is an assembly of battery cells that deliver a targeted range of voltage and current for a duration of time against expected load scenarios. The BMS typically monitors the battery pack, provides battery protection, estimates the battery's operational state, optimizes battery performance, and reports operational status to devices in the electric vehicle.

Various rechargeable cells, such as lithium-ion cells, perform well in electric vehicles; however, they have drawbacks when operated outside a safe operating range, with outcomes ranging from compromising the battery performance to dangerous conditions, such as thermal runaway. The BMS assists with battery pack protection management and capacity management. Battery pack protection management can include electrical protection, which involves not allowing the battery to be damaged via usage outside a safe operating range of the battery pack, and thermal protection, which involves temperature control to maintain or bring the battery pack into a safe operating range of the battery pack.

Electrical protection in a BMS can include monitoring battery pack current, cell voltages, and/or cell swelling to know the amount of energy (State of Energy, SOE) and the amount of charge (state of charge, SOC) that is left in the battery pack at its current state of health (SOH) that accounts for aging. In particular, aging and state of health (SOH) is defined by an assessment of the percentage of maximum battery capacity (SOH-C) left in the pack when compared to the fresh pack capacity. Another surrogate state of health (SOH) metric is based on the increase in series resistance (R) when compared to the fresh pack resistance. These estimations can predict the electric vehicle (EV) range and the allowable power transfer in hybrid electric vehicles (HEV). These estimations may also be combined to estimate the time needed to discharge the pack given an electrical or a heat sink.

Although the vehicle has many onboard algorithms in its computer and in the cloud for making these estimations, verifying and certifying these battery pack characteristics, such as State of Certified Energy (SOCE) and State of Certified Range (SOCR) as a percentage of the certified usable battery energy (UBE) (see United Nations Global Technical Regulation (UN GTR No. 22, 2022) In-vehicle battery durability for electrified vehicles. 2022) usually requires the battery pack to discharge by generating traction force when the vehicle is on a laboratory dynamometer, or by connecting the battery pack to a battery bidirectional charger that can transfer energy from the vehicle to the grid with EV supply equipment (EVSE) attached to it. It would be beneficial if a method and system were available that could determine the stored battery pack resistance and usable energy in an electric vehicle without the need to generate traction force to move the vehicle and/or without the need to connect the battery pack to a battery cycler in a lab.

Thermal protection in a BMS can include monitoring battery pack current, cell voltages, and cell temperature during charging and discharging operation to prevent the current, voltage, and temperature of any cell or battery pack from operating outside the safe operating range of the battery pack. If limits are exceeded for a length of time, dangerous thermal runaway conditions could occur. Both the likelihood and severity of battery thermal runaway decrease with decreasing SOC. If a fire occurs within one battery pack wherein neighboring battery packs are potentially at high SOC, a fire can propagate to neighboring battery packs. Also, if a fire occurs within one EV parked in close proximity to other EVs, where neighboring vehicles are potentially at high SOC, a fire can propagate to neighboring EVs. It would be beneficial if a method and system were available in which a battery pack of an EV could be discharged before the fire can propagate, and then the reduced heat generation may be low enough to prevent or at least slow the propagation.

Furthermore, in the event of an emergency following an accident or immobilization, emergency responders can be exposed to high voltage if EVs or HEVs are involved. Generally, a high voltage interlock loop (HVIL) is present in the vehicle for the emergency responders to disconnect and open the high voltage contactors in the vehicle. However, the HVIL does not have a standardized location across vehicle platforms, the emergency responders must gain access inside the vehicle to disconnect the HVIL, and the battery pack itself still maintains a high voltage potential, which may be damaged and exposed to the emergency responders. It would be beneficial if the battery pack could be discharged by the vehicle itself through the use of on-board electrical loads and heat sinks.

What is needed therefore are improved methods for determining one or more characteristics of a battery pack in an electric vehicle, and improved methods for mitigating or avoiding an unsafe condition (e.g., thermal runaway) in a battery pack in an electric vehicle, especially in the case where emergency responders must approach and engage with the vehicle.

### SUMMARY

The foregoing needs are met by electric vehicles according to the present disclosure, a method according to the present disclosure for determining one or more characteristics of a battery pack in an electric vehicle, and a method according to the present disclosure for mitigating or avoiding an unsafe condition in a battery pack in an electric vehicle.

The present disclosure describes how the role of electric traction motors in an electric vehicle can be extended to improve battery pack management by acting as an energy dissipation device, allowing the battery pack to discharge without generating traction force to move the vehicle. By providing energy dissipation across a wide range of currents/powers, the electric traction motor can operate as a controllable load to discharge the pack down to desired end conditions for battery diagnostics and safety, e.g., state-of-charge, state-of-health, voltage, or cut-off current, similar to discharge-related battery cycler operations in the lab.

For battery diagnostics, using the motor for energy dissipation allows the application of common battery characterization tests performed in the lab to improve estimates of key performance indicators like SOC and SOH as the battery pack ages. For example, a slow constant-current, constant-voltage (CCCV) discharge can provide an updated estimate of the full pack capacity and degradation mechanisms, while discharge pulses with long relaxations can provide information about resistance growth and power loss. Additionally, recommendations for safe EV storage and transport may specify an upper SOC limit. To meet the criteria, the electric vehicle battery pack can be discharged through the electric traction motor rather than having to drive additional miles or to discharge in a vehicle-to-grid (V2G) fashion through an EV supply equipment (EVSE).

Under emergency circumstances like an approaching fire due to external causes, the electric traction motor can proactively dissipate the remaining energy in the battery pack to mitigate or avoid battery thermal runaway in the current vehicle. The emergency discharge can slow and prevent fire propagation from neighboring vehicles by creating a firebreak and removing otherwise stranded or inaccessible energy that can lead to later fire reignitions. A controller can continually manage the emergency discharge by determining the discharge power based on the urgency of the threat and the energy dissipation capacity of the motor and other auxiliary vehicle loads (e.g., HVAC). The controller can consider the physical limitations of each device, coordinating and limiting the rate of energy dissipation for each device as high motor discharge power can lead to high temperatures and permanent damage.

In one aspect, the present disclosure provides an electric vehicle which comprises: a battery pack; an electric traction motor for selectively driving at least one driving wheel of the vehicle; a DC-AC inverter in electrical communication with the battery pack and the electric traction motor; one or more electrical loads in electrical communication with the battery pack; and a battery management system including a controller in electrical communication with the battery pack and the inverter and the one or more electrical loads. The controller is configured to execute a program stored in the controller to: (i) receive electrical signals based on readings from a sensor in or adjacent the battery pack, (ii) determine whether one or more of the electrical signals exceeds a safety threshold, and (iii) when the one or more of the electrical signals exceeds the safety threshold, cause electricity to flow from the battery pack to the inverter and/or to the one or more electrical loads to dissipate energy stored in the battery pack. In one embodiment of the electric vehicle, the sensor comprises a temperature sensor, and the safety threshold comprises a temperature threshold that indicates thermal runaway of the battery pack.

In another aspect, the present disclosure provides an electric vehicle which comprises: a battery pack; an electric traction motor for selectively driving at least one driving wheel of the vehicle; a DC-AC inverter in electrical communication with the battery pack and the electric traction motor; one or more electrical loads in electrical communication with the battery pack; and a battery management system including a controller in electrical communication with the battery pack and the inverter and the one or more electrical loads. The controller is configured to execute a program stored in the controller to: (i) cause electricity to flow from the battery pack to the inverter and/or to the one or more electrical loads to dissipate energy stored in the battery pack, and (ii) calculate a battery pack characteristic during or after when the electricity flows from the battery pack to the inverter and/or to the one or more electrical loads to dissipate energy stored in the battery pack.

In yet another aspect, the present disclosure provides a method for determining a characteristic of a battery pack in an electric vehicle including an electric traction motor for selectively driving at least one driving wheel of the vehicle, a DC-AC inverter in electrical communication with the battery pack and the electric traction motor, and one or more electrical loads in electrical communication with the battery pack. The method comprises: (a) providing a controller in electrical communication with the battery pack and the inverter and the one or more electrical loads; (b) causing, in the controller, electricity to flow from the battery pack to the inverter and/or to the one or more electrical loads to dissipate energy stored in the battery pack; and (c) calculating, in the controller, a battery pack characteristic during or after when the electricity flows from the battery pack to the inverter and/or to the one or more electrical loads to dissipate energy stored in the battery pack.

In still another aspect, the present disclosure provides a method for mitigating or avoiding an unsafe condition in a battery pack in an electric vehicle including an electric traction motor for selectively driving at least one driving wheel of the vehicle, a DC-AC inverter in electrical communication with the battery pack and the electric traction motor, and one or more electrical loads in electrical communication with the battery pack. The method comprises: (a) receiving, in a controller in electrical communication with the battery pack and the inverter and the one or more electrical loads, electrical signals based on readings from a sensor in or adjacent the battery pack; (b) determining, in the controller, whether one or more of the electrical signals exceeds a safety threshold, and (c) when the one or more of the electrical signals exceeds the safety threshold, causing electricity to flow from the battery pack to the inverter and/or to the one or more electrical loads to dissipate energy stored in the battery pack.

It is an advantage of the present disclosure to provide methods and EVs that control the main vehicle loads including the traction motor, AC compressors, and cabin heaters, in addition to other auxiliary loads to enable a controllable battery discharge instead of performing the conventionally intended function of these devices.

It is another advantage of the present disclosure to enable a controllable battery discharge for specific unconventional reasons such as: (i) emergency battery discharge, and (ii) active and tailored diagnostics for state-of-charge and/or state-of-health estimation. To achieve these advantages, motors and other auxiliary vehicle equipment are controlled to dissipate the energy stored in a battery as heat for a continuous period or for small pulses that will provide richer diagnostics for the battery cells and/or battery pack.

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF DRAWINGS

FIG. 1 is a schematic diagram representation of an electric vehicle according to one embodiment of the present disclosure showing an overview of a battery pack and electric traction motor heat dissipation. Discharge current from the battery pack is determined by the total energy dissipation (Pₗₒₛₛ), calculated by a controller to maintain the temperature for the battery pack (T_{batt}), traction motor(s) (T_{EM}), and other energy dissipation loads within safe limits.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. Skilled artisans will recognize the examples provided herein have many useful alternatives and fall within the scope of embodiments of the invention.

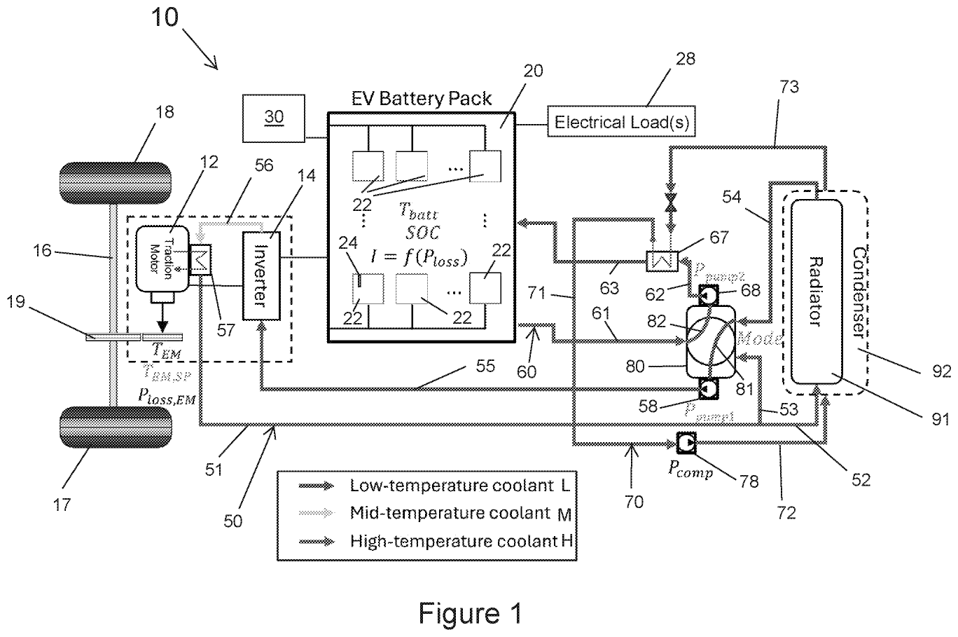

Turning now to FIG. 1, there is shown an electric vehicle 10 according to one non-limiting example embodiment of the present invention. The electric vehicle 10 includes an electric traction motor 12 and a DC-AC inverter 14 in electrical communication with the electric traction motor 12. The electric vehicle 10 includes a driving wheel 17 and a driving wheel 18 mounted on an axle 16. A transmission 19 controls transmission of rotational motion from the electric traction motor 12 to the axle 16 to drive the wheels 17,18.

The electric vehicle 10 includes a battery pack 20 having battery cells 22. A sensor 24 is in or adjacent to any number of the battery cells 22. The battery pack 20 is in electrical communication with the DC-AC inverter 14, one or more electrical loads 28 (e.g., vehicle air conditioning, vehicle cabin heating, vehicle lighting, or any combination thereof), and a battery management system including a controller 30 having a microprocessor under the control of a software program stored in the memory of the controller 30.

In one embodiment, the electric traction motor 12 can convert electricity into motion through use of a rotor and a stator. The DC-AC inverter 14 converts the DC power supplied by the battery pack 20 into AC power which is sent to the stator of the electric traction motor 12. The stator generates a magnetic field when current flows through it. The magnetic field of the stator interacts with the rotor and causes the rotor to spin. The rotation of the rotor is transferred to the wheels 17, 18 of the electric vehicle 10. A motor controller is used to regulate speed and torque by controlling the current supplied to the stator.

The electric vehicle 10 includes a first coolant loop 50 having a first section 51 containing the coolant at high-temperature H, a second section 52 containing the coolant at high-temperature H, a third section 53 containing the coolant at high-temperature H, a fourth section 54 containing the coolant at low-temperature L, a fifth section 55 containing the coolant at low-temperature L, and a sixth section 56 containing the coolant at mid-temperature M. The second section 52 and the fourth section 54 of the first coolant loop 50 are in fluid communication with a radiator 91. The third section 53, the fourth section 54, and the fifth section 55 are in fluid communication with a fluid control valve 80. The first section 51 and the sixth section 56 of the first coolant loop 50 are in fluid communication with a first heat exchanger 57 that receives heat from the electric traction motor 12. The fifth section 55 and the fluid control valve 80 are in fluid communication with a first circulation pump 58 of the first coolant loop 50.

The electric vehicle 10 also includes a second coolant loop 60 having a first section 61 containing the coolant at high-temperature H, a second section 62 containing the coolant at high-temperature H, and a third section 33 containing the coolant at low-temperature L. The first section 61 and the second section 62 are in fluid communication with the fluid control valve 80. The second section 62 and the third section 63 of the second coolant loop 60 are in fluid communication with a second heat exchanger 67. The second section 62 and the fluid control valve 80 are in fluid communication with a second circulation pump 68 of the second coolant loop 60.

The electric vehicle 10 also includes a third coolant loop 70 having a first section 71 containing the coolant at high-temperature H, a second section 72 containing the coolant at high-temperature H, and a third section 73 containing the coolant at low-temperature L. The first section 71 and the second section 72 of the third coolant loop 70 are in fluid communication with a third pump 78 of the third coolant loop 70. The second section 72 and the third section 73 of the third coolant loop 70 are in fluid communication with a condenser 92. The third section 73 of the third coolant loop 70 is in fluid communication with the condenser 92 and the second heat exchanger 67.

The fluid control valve 80 regulates the flow of coolant in the first coolant loop 50 and the second coolant loop 60. As shown in FIG. 1, the fluid control valve 80 is alterable between a first position 81 and a second position 82. The fluid control valve 80 may be actuated by control signals from the controller 30 to transition from the first position 81 to the second position 82. In the first position 81 of the fluid control valve 80, coolant flows to the first heat exchanger 57, the DC-AC inverter 14, and the radiator 91, and in the second position 82 of the fluid control valve 80, coolant flows to the battery pack 20, and the second heat exchanger 67.

In one embodiment of the electric vehicle 10, the controller 30 is configured to execute a program stored in the controller 30 to: (i) receive electrical signals based on readings from a sensor 24 in or adjacent the battery pack 20, (ii) determine whether one or more of the electrical signals exceeds a safety threshold, and (iii) when the one or more of the electrical signals exceeds the safety threshold, cause electricity to flow from the battery pack 20 to the DC-AC inverter 14 and/or to the one or more electrical loads 28 to dissipate energy stored in the battery pack 20. In one embodiment of the electric vehicle 10, the sensor 24 comprises a temperature sensor, and the safety threshold comprises a temperature threshold that indicates thermal runaway of the battery pack 20. The controller 30 can execute the program stored in the controller 30 to cause electricity to flow from the battery pack 20 to the one or more electrical loads 28 to dissipate energy stored in the battery pack 20. The one or more electrical loads can be selected from vehicle air conditioning, vehicle cabin heating, vehicle lighting, or any combination thereof. The controller 30 can execute the program stored in the controller 30 to cause electricity to flow from the battery pack 20 to the one or more electrical loads 28 to dissipate energy stored in the battery pack 20 as heat for a continuous period. The controller 30 can execute the program stored in the controller 30 to adjust an electrical discharge rate from the battery pack 20 to the one or more electrical loads 28 to dissipate energy stored in the battery pack 20 based on a safety metric of the one or more electrical loads 28. The safety metric can be an energy dissipation capacity of the one or more electrical loads 28.

In one embodiment of the electric vehicle 10, the controller 30 can execute the program stored in the controller 30 to cause electricity to flow from the battery pack 20 to the DC-AC inverter 14 to dissipate energy stored in the battery pack 20. The controller 30 can execute the program stored in the controller 30 to cause the DC-AC inverter 14 to direct energy stored in the battery pack 20 to the electric traction motor 12 to dissipate energy stored in the battery pack 20. The controller 30 can execute the program stored in the controller 30 to cause the DC-AC inverter 14 to direct energy stored in the battery pack 20 to the electric traction motor 12 to dissipate energy stored in the battery pack 20 without generating torque to drive the wheels 17, 18 of the electric vehicle 10. The controller 30 can execute the program stored in the controller 30 to cause the DC-AC inverter 14 to direct energy stored in the battery pack 20 to the electric traction motor 12 with only direct axis current in the two-phase rotating reference frame so the electric traction motor 12 does not generate torque and drive the driving wheels 17, 18 of the electric vehicle 10. The controller 30 can execute the program stored in the controller 30 to cause electricity to flow from the battery pack 20 to the DC-AC inverter 14 to dissipate energy stored in the battery pack as heat for a continuous period. The controller 30 can execute the program stored in the controller 30 to adjust an electrical discharge rate from the battery pack 20 to the DC-AC inverter 14 to dissipate energy stored in the battery pack 20 based on a safety metric of the DC-AC inverter 14 and/or the electric traction motor 12. The safety metric can be an energy dissipation capacity or current limit of the DC-AC inverter 14 and/or the electric traction motor 12. The controller 30 can execute the program stored in the controller 30 to adjust the electrical discharge rate based on a total energy dissipation (Pₗₒₛₛ) calculated to maintain a battery pack temperature (T_{batt}) and an electric traction motor temperature (T_{EM}) within safe limits.

In another embodiment of the electric vehicle 10, the controller 30 is configured to execute a program stored in the controller 30 to: (i) cause electricity to flow from the battery pack 20 to the DC-AC inverter 14 and/or to the one or more electrical loads 28 to dissipate energy stored in the battery pack 20, and (ii) calculate a battery pack characteristic during or after when the electricity flows from the battery pack 20 to the DC-AC inverter 14 and/or to the one or more electrical loads 28 to dissipate energy stored in the battery pack 20. The controller 30 can execute the program stored in the controller 30 to calculate the battery pack characteristic when the battery pack reaches an end condition selected from a state-of-charge (SOC), a cut-off voltage, a cut-off current, or any combination thereof. The controller 30 can execute the program stored in the controller 30 to cause electricity to flow from the battery pack 20 to the DC-AC inverter 14 and/or to the one or more electrical loads 28 to dissipate energy stored in the battery pack 20 as heat for a continuous period. The controller 30 can execute the program stored in the controller 30 to cause electricity to flow from the battery pack 20 to the DC-AC inverter 14 and/or to the one or more electrical loads 28 using pulses to dissipate energy stored in the battery pack 20 as heat. The battery pack operating characteristic can be selected from state of charge, state of health, maximum temperature, or any combination thereof.

In one embodiment of the electric vehicle 10, the controller 30 is configured to execute a program stored in the controller 30 to cause electricity to flow from the battery pack 20 to the one or more electrical loads 28 to dissipate energy stored in the battery pack 20. The one or more electrical loads can be selected from vehicle air conditioning, vehicle cabin heating, vehicle lighting, or any combination thereof.

In one embodiment of the electric vehicle 10, the controller 30 is configured to execute a program stored in the controller 30 to cause electricity to flow from the battery pack 20 to the DC-AC inverter 14 to dissipate energy stored in the battery pack 20. The controller 30 can execute the program stored in the controller 30 to cause the DC-AC inverter 14 to direct energy stored in the battery pack 20 to the electric traction motor 12 to dissipate energy stored in the battery pack 20. The controller 30 can execute the program stored in the controller 30 to cause the DC-AC inverter 14 to direct energy stored in the battery pack 20 to the electric traction motor 12 to dissipate energy stored in the battery pack 20 without driving the driving wheels 17, 18 of the electric vehicle 10. The controller 30 can execute the program stored in the controller 30 to cause the DC-AC inverter 14 to direct energy stored in the battery pack 20 to the electric traction motor 12 with only direct axis current in the two-phase rotating reference frame that does not generate torque in the electric motor 12 and therefore does not drive the driving wheels 17, 18 of the electric vehicle 10.

In yet another embodiment, the present invention provides a method for determining a characteristic of a battery pack 20 in an electric vehicle 10 including an electric traction motor 12 for selectively driving wheels 17, 18 of the vehicle 10, a DC-AC inverter 14 in electrical communication with the battery pack 20 and the electric traction motor 12, and one or more electrical loads 28 in electrical communication with the battery pack 20. The method comprises: (a) providing a controller 30 in electrical communication with the battery pack 20 and the DC-AC inverter 14 and the one or more electrical loads 28; (b) causing, in the controller 30, electricity to flow from the battery pack 20 to the DC-AC inverter 14 and/or to the one or more electrical loads 28 to dissipate energy stored in the battery pack 20; and (c) calculating, in the controller 30, a battery pack characteristic during or after when the electricity flows from the battery pack 20 to the DC-AC inverter 14 and/or to the one or more electrical loads 28 to dissipate energy stored in the battery pack.

In one embodiment of the method, the controller 30 calculates the battery pack characteristic when the battery pack 20 reaches an end condition selected from a state-of-charge (SOC), a cut-off voltage, a cut-off current, or any combination thereof.

In the method, the controller 30 can cause electricity to flow from the battery pack 20 to the DC-AC inverter 14 and/or to the one or more electrical loads 28 to dissipate energy stored in the battery pack 20 as heat for a continuous period. In the method, the controller 30 can cause electricity to flow from the battery pack 20 to the DC-AC inverter 14 and/or to the one or more electrical loads 28 using pulses to dissipate energy stored in the battery pack 20 as heat. The battery pack operating characteristic can be selected from state of charge, state of health, maximum temperature, or any combination thereof. In the method, the controller 30 can cause electricity to flow from the battery pack 20 to the one or more electrical loads 28 to dissipate energy stored in the battery pack 20. The one or more electrical loads 28 can be selected from vehicle air conditioning, vehicle cabin heating, vehicle lighting, or any combination thereof. In the method, the controller 30 can cause electricity to flow from the battery pack 20 to the DC-AC inverter 14 to dissipate energy stored in the battery pack 20. In the method, the controller 30 can cause the DC-AC inverter 14 to direct energy stored in the battery pack 20 to the electric traction motor 12 to dissipate energy stored in the battery pack 20. In the method, the controller 30 can cause the DC-AC inverter 14 to direct energy stored in the battery pack 20 to the electric traction motor 12 to dissipate energy stored in the battery pack 20 without driving the wheels 17, 18 of the electric vehicle 10. In the method, the controller 30 can cause the DC-AC inverter 14 to direct energy stored in the battery pack 20 to the electric traction motor 12 with only direct axis current in the two-phase rotating reference frame that does not generate torque in the electric motor 12 and therefore does not drive the driving wheels 17, 18 of the electric vehicle 10.

In still another embodiment, the present invention provides a method for mitigating or avoiding an unsafe condition in a battery pack 20 in an electric vehicle 10 including a DC-AC inverter 14 in electrical communication with the battery pack 20 and the electric traction motor 12, and one or more electrical loads 28 in electrical communication with the battery pack 20. The method comprises: (a) receiving, in a controller 30 in electrical communication with the battery pack 20 and the DC-AC inverter 14 and the one or more electrical loads 28, electrical signals based on readings from a sensor 24 in or adjacent the battery pack 20; (b) determining, in the controller 30, whether one or more of the electrical signals exceeds a safety threshold, and (c) when the one or more of the electrical signals exceeds the safety threshold, causing electricity to flow from the battery pack 20 to the DC-AC inverter 14 and/or to the one or more electrical loads 28 to dissipate energy stored in the battery pack 20. In one embodiment of the method, the sensor comprises a temperature sensor. In one embodiment of the method, the unsafe condition is battery thermal runaway. In the method, the controller 30 can cause electricity to flow from the battery pack 20 to the one or more electrical loads 28 to dissipate energy stored in the battery pack. The one or more electrical loads can be selected from vehicle air conditioning, vehicle cabin heating, vehicle lighting, or any combination thereof. In the method, the controller 30 can cause electricity to flow from the battery pack 20 to the DC-AC inverter 14 to dissipate energy stored in the battery pack 20. In the method, the controller 30 can cause the DC-AC inverter 14 to direct energy stored in the battery pack 20 to the electric traction motor 12 to dissipate energy stored in the battery pack 20. In the method, the controller 30 can cause the DC-AC inverter 14 to direct energy stored in the battery pack 20 to the electric traction motor 12 to dissipate energy stored in the battery pack 20 without driving the wheels 17, 18 of the electric vehicle 10. In the method, the controller 30 can cause the DC-AC inverter 14 to direct energy stored in the battery pack 20 to the electric traction motor 12 as direct axis current in a two-phase rotating reference frame such that the electric traction motor 12 does not drive the wheels 17,18 of the electric vehicle 10. In the method, the controller 30 can cause electricity to flow from the battery pack 20 to the DC-AC inverter 14 and/or to the one or more electrical loads 28 to dissipate energy stored in the battery pack 20 as heat for a continuous period. In the method, the controller 30 can adjust an electrical discharge rate from the battery pack 20 to the DC-AC inverter 14 and/or to the one or more electrical loads 28 to dissipate energy stored in the battery pack 20 based on a safety metric of the DC-AC inverter 14, and/or the electric traction motor, and/or the one or more electrical loads 28. The safety metric can be an energy dissipation capacity of the DC-AC inverter 14, and/or the electric traction motor, and/or the one or more electrical loads 28. In the method, the controller 30 can adjust the electrical discharge rate based on a total energy dissipation (Pₗₒₛₛ) calculated to maintain a battery pack temperature (T_{batt}) and an electric traction motor temperature (T_{EM}) within safe limits.

Thus, the present invention provides electric vehicles including on-board energy dissipation, methods of using on-board energy dissipation for determining a characteristic of a battery pack in an electric vehicle, and methods using on-board energy dissipation for mitigating or avoiding an unsafe condition in a battery pack in an electric vehicle.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

What is claimed is:

1. An electric vehicle comprising:
a battery pack;
an electric traction motor for selectively driving at least one driving wheel of the vehicle;
a DC-AC inverter in electrical communication with the battery pack and the electric traction motor;
one or more electrical loads in electrical communication with the battery pack; and
a battery management system including a controller in electrical communication with the battery pack and the inverter and the one or more electrical loads, the controller being configured to execute a program stored in the controller to:
(i) receive electrical signals based on readings from a sensor in or adjacent the battery pack,
(ii) determine whether one or more of the electrical signals exceeds a safety threshold, and
(iii) when the one or more of the electrical signals exceeds the safety threshold, cause electricity to flow from the battery pack to the inverter and/or to the one or more electrical loads to dissipate energy stored in the battery pack.

2. The electric vehicle of claim 1 wherein:
the sensor comprises a temperature sensor, and
the safety threshold comprises a temperature threshold that indicates thermal runaway of the battery pack.

3. The electric vehicle of claim 1 wherein:
the one or more electrical loads is selected from vehicle air conditioning, vehicle cabin heating, vehicle lighting, or any combination thereof.

4. The electric vehicle of claim 1 wherein:
the controller executes the program stored in the controller to cause electricity to flow from the battery pack to the one or more electrical loads to dissipate energy stored in the battery pack.

5. The electric vehicle of claim 4 wherein:
the one or more electrical loads is vehicle air conditioning.

6. The electric vehicle of claim 1 wherein:
the controller executes the program stored in the controller to cause electricity to flow from the battery pack to the inverter to dissipate energy stored in the battery pack.

7. The electric vehicle of claim 6 wherein:
the controller executes the program stored in the controller to cause the inverter to direct energy stored in the battery pack to the electric traction motor to dissipate energy stored in the battery pack.

8. The electric vehicle of claim 6 wherein:
the controller executes the program stored in the controller to cause the inverter to direct energy stored in the battery pack to the electric traction motor to dissipate energy stored in the battery pack without driving the at least one driving wheel of the vehicle.

9. The electric vehicle of claim 8 wherein:
the controller executes the program stored in the controller to cause the inverter to direct energy stored in the battery pack to the electric traction motor with only direct axis current in a two-phase rotating reference frame such that the electric traction motor does not drive the at least one driving wheel of the vehicle.

10. The electric vehicle of claim 1 wherein:
the controller executes the program stored in the controller to cause electricity to flow from the battery pack to the inverter and/or to the one or more electrical loads to dissipate energy stored in the battery pack as heat for a continuous period.

11. The electric vehicle of claim 1 wherein:
the controller executes the program stored in the controller to adjust an electrical discharge rate from the battery pack to the inverter and/or to the one or more electrical loads to dissipate energy stored in the battery pack based on a safety metric of the inverter, and/or the electric traction motor, and/or the one or more electrical loads.

12. The electric vehicle of claim 11 wherein:
the safety metric is an energy dissipation capacity of the inverter, and/or the electric traction motor, and/or the one or more electrical loads.

13. The electric vehicle of claim 11 wherein:
the controller executes the program stored in the controller to adjust the electrical discharge rate based on a total energy dissipation (Pₗₒₛₛ) calculated to maintain a battery pack temperature (T_{batt}) and an electric traction motor temperature (T_{EM}) within safe limits.

14. The electric vehicle of claim 1 further comprising:
a coolant loop in fluid communication with the electric traction motor, the inverter, and a radiator.

15. The electric vehicle of claim 1 further comprising:
a heat exchanger in thermal communication with the electric traction motor; and
a coolant loop in fluid communication with the heat exchanger, the inverter, a radiator, and a fluid control valve.

16. The electric vehicle of claim 1 further comprising:
a coolant loop in fluid communication with the battery pack, a fluid control valve, and a heat exchanger.

17. The electric vehicle of claim 1 further comprising:
a first heat exchanger in thermal communication with the electric traction motor;
a first coolant loop in fluid communication with the first heat exchanger, the inverter, a radiator, and a fluid control valve; and
a second coolant loop in fluid communication with the battery pack, the fluid control valve, and a second heat exchanger.

18. The electric vehicle of claim 17 wherein:
the fluid control valve includes a first position in which a first coolant flows to the first heat exchanger, the inverter, and the radiator, and
the fluid control valve includes a second position in which a second coolant flows to the battery pack, and the second heat exchanger.

19. The electric vehicle of claim 18 further comprising:
a third coolant loop in fluid communication with the battery pack, the second heat exchanger and a condenser.

20. The electric vehicle of claim 18 further comprising:
a first pump in fluid communication with the first coolant loop;
a second pump in fluid communication with the second coolant loop; and
a third pump in fluid communication with the third coolant loop.

21. An electric vehicle comprising:
a battery pack;
an electric traction motor for selectively driving at least one driving wheel of the vehicle;
a DC-AC inverter in electrical communication with the battery pack and the electric traction motor;
one or more electrical loads in electrical communication with the battery pack; and
a battery management system including a controller in electrical communication with the battery pack and the inverter and the one or more electrical loads, the controller being configured to execute a program stored in the controller to:
(i) cause electricity to flow from the battery pack to the inverter and/or to the one or more electrical loads to dissipate energy stored in the battery pack, and
(ii) calculate a battery pack characteristic during or after when the electricity flows from the battery pack to the inverter and/or to the one or more electrical loads to dissipate energy stored in the battery pack.

22. The electric vehicle of claim 21 wherein:
the controller executes the program stored in the controller to calculate the battery pack characteristic when the battery pack reaches an end condition selected from a state-of-charge (SOC), a cut-off voltage, a cut-off current, or any combination thereof.

23. The electric vehicle of claim 21 wherein:
the controller executes the program stored in the controller to cause electricity to flow from the battery pack to the inverter and/or to the one or more electrical loads to dissipate energy stored in the battery pack as heat for a continuous period.

24. The electric vehicle of claim 21 wherein:
the controller executes the program stored in the controller to cause electricity to flow from the battery pack to the inverter and/or to the one or more electrical loads using pulses to dissipate energy stored in the battery pack as heat.

25. The electric vehicle of claim 21 wherein:
the battery pack operating characteristic is selected from state of charge, state of health, maximum temperature, or any combination thereof.

26. The electric vehicle of claim 21 wherein:
the controller executes the program stored in the controller to cause electricity to flow from the battery pack to the one or more electrical loads to dissipate energy stored in the battery pack.

27. The electric vehicle of claim 21 wherein:
the one or more electrical loads is selected from vehicle air conditioning, vehicle cabin heating, vehicle lighting, or any combination thereof.

28. The electric vehicle of claim 21 wherein:
the controller executes the program stored in the controller to cause electricity to flow from the battery pack to the inverter to dissipate energy stored in the battery pack.

29. The electric vehicle of claim 28 wherein:
the controller executes the program stored in the controller to cause the inverter to direct energy stored in the battery pack to the electric traction motor to dissipate energy stored in the battery pack.

30. The electric vehicle of claim 28 wherein:
the controller executes the program stored in the controller to cause the inverter to direct energy stored in the battery pack to the electric traction motor to dissipate energy stored in the battery pack without driving the at least one driving wheel of the vehicle.

31. The electric vehicle of claim 30 wherein:
the controller executes the program stored in the controller to cause the inverter to direct energy stored in the battery pack to the electric traction motor through only direct axis current in a two-phase rotating reference frame such that that the electric traction motor does not drive the at least one driving wheel of the vehicle.

32. A method for determining a characteristic of a battery pack in an electric vehicle including an electric traction motor for selectively driving at least one driving wheel of the vehicle, a DC-AC inverter in electrical communication with the battery pack and the electric traction motor, and one or more electrical loads in electrical communication with the battery pack, the method comprising:
(a) providing a controller in electrical communication with the battery pack and the inverter and the one or more electrical loads;
(b) causing, in the controller, electricity to flow from the battery pack to the inverter and/or to the one or more electrical loads to dissipate energy stored in the battery pack; and
(c) calculating, in the controller, a battery pack characteristic during or after when the electricity flows from the battery pack to the inverter and/or to the one or more electrical loads to dissipate energy stored in the battery pack.

33. The method of claim 32 wherein:
the controller calculates the battery pack characteristic when the battery pack reaches an end condition selected from a state-of-charge (SOC), a cut-off voltage, a cut-off current, or any combination thereof.

34. The method of claim 32 wherein:
the controller causes electricity to flow from the battery pack to the inverter and/or to the one or more electrical loads to dissipate energy stored in the battery pack as heat for a continuous period.

35. The method of claim 32 wherein:
the controller causes electricity to flow from the battery pack to the inverter and/or to the one or more electrical loads using pulses to dissipate energy stored in the battery pack as heat.

36. The method of claim 32 wherein:
the battery pack operating characteristic is selected from state of charge, state of health, maximum temperature, or any combination thereof.

37. The method of claim 32 wherein:
the controller causes electricity to flow from the battery pack to the one or more electrical loads to dissipate energy stored in the battery pack.

38. The method of claim 32 wherein:
the one or more electrical loads is selected from vehicle air conditioning, vehicle cabin heating, vehicle lighting, or any combination thereof.

39. The method of claim 32 wherein:
the controller causes electricity to flow from the battery pack to the inverter to dissipate energy stored in the battery pack.

40. The method of claim 32 wherein:
the controller causes the inverter to direct energy stored in the battery pack to the electric traction motor to dissipate energy stored in the battery pack.

41. The method of claim 32 wherein:
the controller causes the inverter to direct energy stored in the battery pack to the electric traction motor to dissipate energy stored in the battery pack without driving the at least one driving wheel of the vehicle.

42. The method of claim 32 wherein:
the controller causes the inverter to direct energy stored in the battery pack to the electric traction motor only as direct axis current in a two-phase rotating reference frame such that the electric traction motor does not drive the at least one driving wheel of the vehicle.

43. A method for mitigating or avoiding an unsafe condition in a battery pack in an electric vehicle including an electric traction motor for selectively driving at least one driving wheel of the vehicle, a DC-AC inverter in electrical communication with the battery pack and the electric traction motor, and one or more electrical loads in electrical communication with the battery pack, the method comprising:
(a) receiving, in a controller in electrical communication with the battery pack and the inverter and the one or more electrical loads, electrical signals based on readings from a sensor in or adjacent the battery pack;
(b) determining, in the controller, whether one or more of the electrical signals exceeds a safety threshold; and
(c) when the one or more of the electrical signals exceeds the safety threshold, causing electricity to flow from the battery pack to the inverter and/or to the one or more electrical loads to dissipate energy stored in the battery pack.

44. The method of claim 43 wherein:
the sensor comprises a temperature sensor.

45. The method of claim 43 wherein:
the unsafe condition is thermal runaway.

46. The method of claim 43 wherein:
the controller causes electricity to flow from the battery pack to the one or more electrical loads to dissipate energy stored in the battery pack.

47. The method of claim 43 wherein:
the one or more electrical loads is selected from vehicle air conditioning, vehicle cabin heating, vehicle lighting, or any combination thereof.

48. The method of claim 43 wherein:
the controller causes electricity to flow from the battery pack to the inverter to dissipate energy stored in the battery pack.

49. The method of claim 48 wherein:
the controller causes the inverter to direct energy stored in the battery pack to the electric traction motor to dissipate energy stored in the battery pack.

50. The method of claim 48 wherein:
the controller causes the inverter to direct energy stored in the battery pack to the electric traction motor to dissipate energy stored in the battery pack without driving the at least one driving wheel of the vehicle.

51. The method of claim 49 wherein:
the controller causes the inverter to direct energy stored in the battery pack to the electric traction motor as direct axis current in a two-phase rotating reference frame such that the electric traction motor does not drive the at least one driving wheel of the vehicle.

52. The method of claim 43 wherein:
the controller causes electricity to flow from the battery pack to the inverter and/or to the one or more electrical loads to dissipate energy stored in the battery pack as heat for a continuous period.

53. The method of claim 43 further comprising:
adjusting an electrical discharge rate from the battery pack to the inverter and/or to the one or more electrical loads to dissipate energy stored in the battery pack based on a safety metric of the inverter, and/or the electric traction motor, and/or the one or more electrical loads.

54. The method of claim 53 wherein:
the safety metric is an energy dissipation capacity of the inverter, and/or the electric traction motor, and/or the one or more electrical loads.

55. The method of claim 53 further comprising:
adjusting the electrical discharge rate based on a total energy dissipation (Pₗₒₛₛ) calculated to maintain a battery pack temperature (T_{batt}) and an electric traction motor temperature (T_{EM}) within safe limits.
